(19) United States
(12) Patent Application Publication
(10) Pub. No.: US 2011/0025268 A1
(43) Pub. Date: Feb. 3, 2011

(54) REPLACING DISCHARGED BATTERIES IN ELECTRIC VEHICLES

(76) Inventor: Jecheskel Davidovitch, Ramat Gan (IL)

Correspondence Address: Pearl Cohen Zedek Latzer, LLP, 1500 Broadway, 12th Floor, New York, NY, 10036, US

(21) Appl. No.: 12/936,776

(22) PCT Filed: Jun. 4, 2009
(86) PCT No.: PCT/IL09/00562

§ 371 Date: Oct. 7, 2010

(30) Foreign Application Priority Data
Apr. 7, 2008 (IL) 190647

(51) Int. Cl. H02J 7/00

(52) U.S. Cl. 320/109; 180/65.29

(57) ABSTRACT

A quick economical re-energizing system of Electric Vehicles {EV}5 intended for replacing discharged electric batteries of Electric Vehicles by charged ones, when there are no “on-boared” means for the continuous charging of batteries, and provided said EV are suitable for the offered re-energizing system, the technique of replacing the discharged batteries by charged ones, automatically {or semi-automatically}, being equivalent to the regular known re-fueling of cars, as regarding the duration of the process and the convenience of drivers and passengers, said re-energizing being enabled due to unique capabilities deriving from a newly invented electric automotive system, like allowing all the four traveling wheels of EV to swivel about their steering axes, at 90 degrees from the travel direction, or like self-elevating and lowering the EVs body in relation to the traveling wheels, as required for the offered re-energizing process of Electric Vehicles.

### BACKGROUND

One of the major limitations of pure electric vehicles {EV} which are not equipped with an “on-board” charging generator, is their travel range before recharging, which nowadays is 100 to 150 km, meaning well bellow the travel range of an “ICE” {Internal Combustion Engine} car of the same category, before refueling.

On the other hand, the duration of the whole cycle of re-charging a discharged battery of an electric vehicle, would be well above the duration of the refueling cycle of an ICE equivalent car.

A reasonable solution for that problem of the electric vehicles, could be a method for replacing the discharged batteries by charged ones, if the duration of said replacing cycle would be more or less equivalent to the regular refueling duration of cars, rather than waiting for the batteries to be recharged.

It is obvious that a sophisticated robot could perform a process of replacing batteries, but that solution could not respond to the main requirement, of being at the same time also economical, as regarding the amount of robots which would be required for responding to the variety of EV models, as each model might be of a different battery and its installation.

It has to be emphasized that even on relating to a single preferred electric vehicle of any type or model, the robot amounts required for of any popular known type or model, would require investments far beyond the economical ones.

It is the object of the present invention to offer a functional and economical method, for replacing discharged batteries by charged ones, within a few minutes.
It will as well be described hereinafter, how the offered method for replacing discharged batteries, may be carried out automatically {or semi-automatically}.

A preferred embodiment of the present invention as illustrated in FIG. 2 hereinafter, is a standard rollers-conveyor utilized regularly for the purpose of materials handling, comprising three sections separated by two gaps, which are wide enough for the wheels of the intended EV to pass through, up to the batteries replacing station of the rollers-conveyor {as clearly shown in FIG. 2}, and narrow enough for the battery-packs to skip over, the three sections of the rollers-conveyor being:
{a} A feeding section, upon which are fed charged batteries taken from their storage, and transferred to the next “batteries replacing section”.
{b} A “batteries replacing section”, upon which are released discharged batteries by said EV, and the charged ones are picked up, locked and connected automatically {or manually} to their electric connections.
{c} A removing section, from which the discharged batteries are removed to the store, for being recharged and supplied fluently to the next clients, in the same manner.

It has to be noted that for operating the EV while all its batteries are removed, a specific integral “service battery”, which does not take part in the replacing cycle, is utilized, serving for that purpose only.

It has also to be realized, that the system for “replacing batteries” presented here, would be of an incomparable lower cost, than the investment in the cheapest system based on a mass of specific robots, intended for a variety of EV models for carrying out the replacing operations, or even if intended for one popular model of wide distribution, which would require numerous highly expensive robots.

The offered solution for the replacement of batteries as presented here, is intended primarily for electric vehicles of four “Suspension-Drive” units, in which all the four suspensions are of the “Vertically Non-guided” type, providing exclusive maneuvering capabilities in three dimensions, and consequently have robotic options.

Said capabilities allow said electric vehicle to perform operations like “Side-traveling”, as well as self-elevating and lowering. These operations form the basis for a full automatic plant for replacing discharged batteries.

Said capabilities, combined with those of the offered “Batteries replacing plant”, will not only provide an inclusive system for replacing batteries, but may also serve for handling and providing a full range of services for the whole “Pure electric transportation” system, possibly including as well replacement of faulty items, rather than repairing, as well as handling recorded preventive maintenance out of garages.

These services may be provided mainly due to the simplicity of the mechanical sub-assemblies of the offered EV, and due to their location adjacent to the periphery of said electric vehicle, not requiring repair pits or lifts.

An additional advantage of the offered replacing plant, may also be the releasing and picking-up automatically the batteries from the conveyor, rather than being loaded and unloaded through the luggage trunk, which may require the removal of goods being inside, thus affecting the continuous flow of the batteries replacing processes, and disturb other services, which require a free approach all around the EV.

The location of the batteries underneath the seats, leaves also more internal space for the passengers and their goods, and allow for a re-design of the interior.

The vehicle's center of gravity also moves towards the center, thus increasing the safety factor of the vehicle.

The invention will now be described with reference to the accompanying drawings, which represent by example preferred embodiments of the invention.
Structural details are shown only as far as necessary for a fundamental understanding. The described examples together with the drawings, will make apparent to those skilled in the art, how further forms of the invention may be realized.

In the drawings:

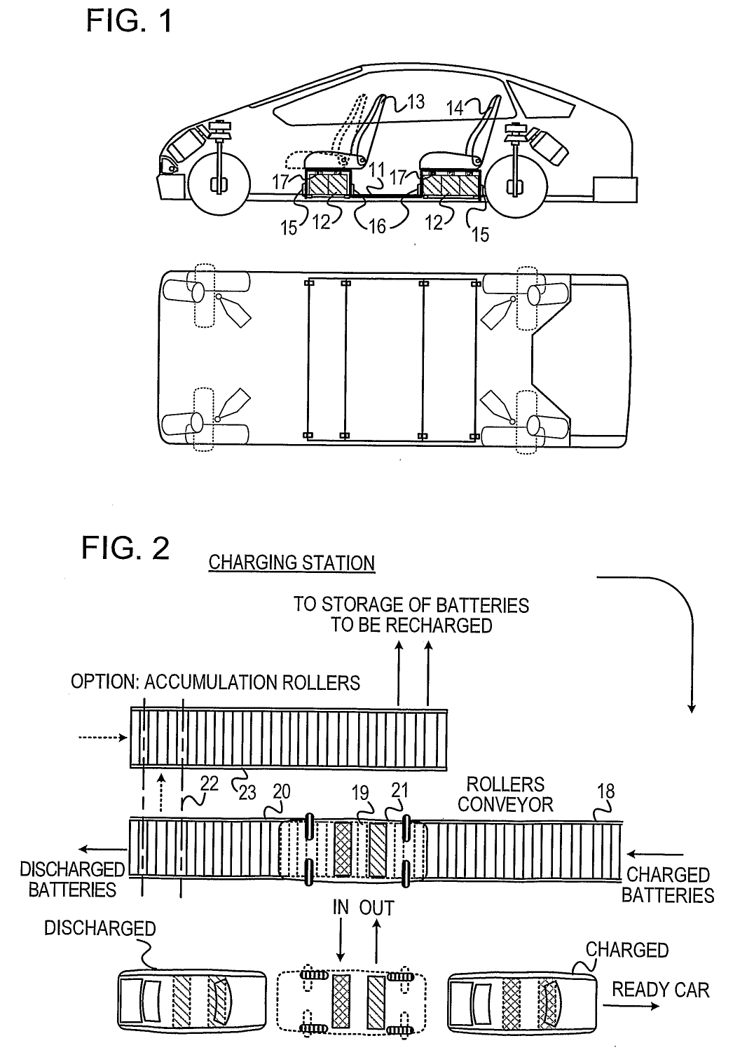

FIG. 1 is a sectioned elevational view of the battery-pack, located within the EV.

FIG. 2 is a top view of the batteries replacing plant, showing the horizontal flow.

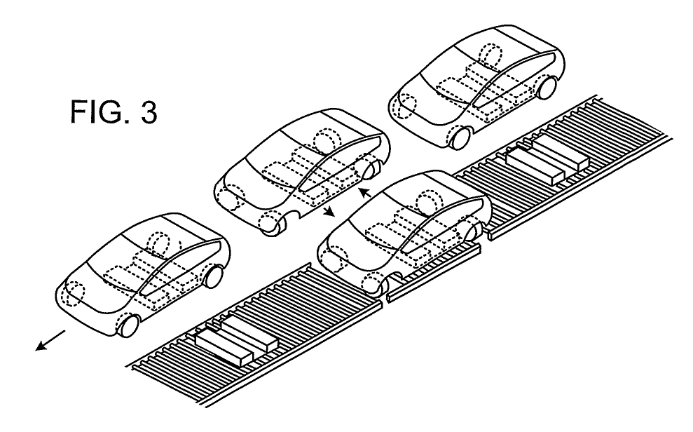

FIG. 3 is a perspective view of the general layout and the sequence of operations.

There is seen in FIG. 1 a “battery-pack”, which consists of a solid frame 11, containing two rows of batteries 12, fitted into two recesses in frame 11, which protrude up to the bottom of the front seats 13 and the rear seat 14.
The front seats 13 may be shifted back and forth, as normal in adjustable car seats. Frame 11 is rigid enough for being released upon any surface, and lifted up by collapsible hooks 15.
On reaching its top position inside the EV, the battery-pack 10 is automatically locked by the tapered locks 16, which are operated electromagnetically, while being also electrically connected to the electric contacts 17.

Turning now to FIG. 2, the batteries replacing plant can be seen as a whole.

The Rollers-Conveyor is Split into Three Sections:
The feeding section 18, to which charged battery-packs are fed.
The replacing section 19, upon which discharged battery-packs are released by the EV 21, and from which charged battery-packs are picked up by the same EV.
The removal section 20, from which the discharged battery-packs are removed.

### The Replacing Process Takes Place as Follows:

The EV 21, which is of a battery-pack to be replaced, is stopped opposite the replacing section 19, its wheels being swiveled automatically to 90 degrees, the EV travels to the replacing section 19 when it becomes vacant, for releasing there its discharged battery-pack. The EV then elevates its body for skipping the discharged battery-pack, and retreats to its waiting station. When section 19 becomes vacant from the discharged battery-pack, and re-loaded by a charged one, the EV 21 travels again towards section 19, until its center-line coincides with that of the replacing section 19, which will cause at that moment the descending of the EV's body down to the charged battery-pack, which will then be gripped by the collapsible hooks 15, locked by the tapered locks 16, and electrically connected to the electric contacts 17 which are located underneath the seats 13 & 14. EV 21 will elevate its body slightly, for traveling safely back to the waiting station, for being picked by its driver.
An additional option is also described, of a pair of chains 22, lifting the discharged battery-packs above the removal section 20, transferring it to the accumulation rollers 23, and descending again for releasing said battery-pack upon said accumulation rollers, for being transferred to the recharging point, or to an intermediate storage.

turning to FIG. 3, for a better understanding of the principles of the offered batteries replacing plant, a perspective view of that plant is shown, illustrating schematically the basic process of the replacing operations, and the flow directions, as well the structure and movements of the battery-packs. The discharged battery-pack are rose-colored, and the charged ones are red colored.

1. A batteries replacing plant, intended for replacing discharged batteries of electric vehicles {EV} within a few minutes; rather than waiting for an integral battery of the EV to be recharged, which could last some hours, said “batteries-replacing plant” including basically a “rollers-conveyor”, of the kind utilized regularly for materials-handling, or a conveyor of any other type, capable of performing equivalent operations, said conveyor comprising three sections separated by two gaps, being wide enough for the wheels of an EV to travel through, up to the batteries replacing station of said conveyor, and narrow enough for the battery-packs to skip over the gaps, the three sections of said conveyor being:
{a} A Feeding section, upon which are fed charged batteries taken from their storage, and transferred to the next “batteries replacing section”,
{b} A “batteries replacing section”, upon which discharged batteries are released automatically {or manually} from said EV, and the charged ones are locked and connected automatically {or manually} to their electric connections,
{c} A removing section, from which the discharged batteries are removed to the store, for being recharged and supplied fluently to the next clients, in the same manner.

2. The batteries replacing plant as claimed in claim 1, the EV being equipped with an integral “service battery” of its own, allowing said EV to perform movements for completing the replacing cycle, while being momentarily left without batteries.

3. The batteries replacing plant as claimed in claim 1, a rigid frame for housing the batteries incorporating two recesses, of a size suiting a full number of battery cells, intended for being inserted into said recesses, which will be fitted into the bases of the front and the rear seats.

4. The batteries replacing plant as claimed in claim 1, the bases of seats 13 and 14 incorporating self-locking hooks, intended for gripping the battery-pack on the reaching of the vehicle's body down, the battery-pack being locked by the tapered lock, and at the same time creating the electric contact with the batteries.

5. The batteries replacing plant as claimed in claim 1, the discharged batteries being picked up by a double chain from the removal section, then released upon accumulation rollers, for being transferred to the charging station. Another option may be adding one or more “rollers conveyors” as a continuation of the first one, leaving gaps between the conveyor sections, as required for a fluent service, thus also enabling an approach from both sides of the conveyor. Loading of charged batteries, and unloading of discharged ones, are carried out longitudinally.

6. The batteries replacing plant as claimed in claim 1, the replacing process of the batteries being carried out on stationary stands, the battery-packs being handled by electric or hydraulic carts, said carts being capable of lifting the battery packs with fixtures to the required heights, for handling the battery packs as done on said conveyors.

7. The batteries replacing plant as claimed in claim 1, substantially as described before, and with reference to the accompanying drawings.

8. (canceled)
